(19) United States
(12) Patent Application Publication
(10) Pub. No.: US 2018/0298763 A1
(43) Pub. Date: Oct. 18, 2018

(54) TURBINE BLADE WITH AXIAL TIP COOLING CIRCUIT

(71) Applicant: Siemens Aktiengesellschaft, München (DE)

(72) Inventors: Ching-Pang Lee, Cincinnati, OH (US); Jae Y. Um, Winter Garden, FL (US); Gerald L. Hillier, Charlottesville, VA (US); Eric Schroeder, Loveland, OH (US); Erik Johnson, Cedar Park, TX (US); Dustin Muller, Cincinnati, OH (US)

(21) Appl. No.: 15/525,820

(22) PCT Filed: Nov. 11, 2014
(86) PCT No.: PCT/US2014/064944

§ 371 Date: May 10, 2017

(51) Int. Cl. F01D 5/18; F01D 5/20

(52) U.S. Cl. CPC F01D 5/187; F01D 5/20; F05D 2250/185; F05D 2260/201; F05D 2220/32; F05D 2240/303; F05D 2240/307; F05D 2240/304; F05D 2260/202

(57) ABSTRACT

The present disclosure provides a turbine blade (12) comprising a leading edge cooling circuit (30), a trailing edge cooling circuit (34), a mid-section cooling circuit (32) comprising a first channel (32a), an intermediate channel (32b), and a final channel (32c), and an axial tip cooling circuit (56). The leading edge, mid-section, and trailing edge cooling circuits (30, 32, 34) each receive a cooling airflow (C_{F}) from a cooling air supply. A radially outer portion of each of the leading edge and mid-section cooling circuits (30, 32) further comprises at least one outlet (62, 64) in fluid communication with the axial tip cooling circuit (56) such that substantially all of a leading edge cooling airflow (LE_{F}) exiting the leading edge cooling circuit (30) and substantially all of a mid-section cooling airflow (MS_{F}) exiting the mid-section cooling circuit (32) is directed to the axial tip cooling circuit (56).

### FIELD OF THE INVENTION

The present invention relates generally to gas turbine blades and, more particularly, to cooling of a blade tip section of a turbine blade.

### BACKGROUND OF THE INVENTION

In a turbomachine, such as a gas turbine engine, compressed air discharged from a compressor section is mixed with fuel and burned in a combustion section to generate hot combustion gases. The combustion gases are directed through a hot gas path in a turbine section, where gases travel through a series of turbine stages typically including a row of stationary vanes followed by a row of rotating turbine blades. The turbine blades extract energy from the hot combustion gases and provide rotation of a turbine rotor for powering the compressor and providing output power.

One type of turbine blade includes an airfoil that extends from a root at a blade platform, which defines the radially inner flowpath for the combustion gases, to a radially outer cap or blade tip section, and includes opposite pressure and suction sides extending axially from leading to trailing edges of the airfoil. Because the turbine blades are directly exposed to the hot combustion gases, they are typically provided with internal cooling circuits that channel a coolant, such as compressor bleed air, through the airfoil of the blade and through various film cooling holes around the surface thereof. In particular, cooling of the leading edge and tip of the turbine blades is achieved largely by film cooling. However, in some applications such as engines burning crude oil or another heavy oil, these film cooling holes can become clogged, leading to overheating and potentially causing damage to the turbine blades.

### SUMMARY OF THE INVENTION

In accordance with one aspect of the invention, the present disclosure provides a turbine blade comprising an outer wall defining a leading edge, a trailing edge, a pressure side wall, a suction side wall, a radially outer end comprising a tip, and a radially inner end coupled to a root, in which the leading edge has no film cooling holes extending therethrough. The turbine blade further comprises a structure defining with the outer wall a leading edge cooling circuit adjacent to the leading edge and extending in a radial direction from the root toward the tip. The leading edge cooling circuit comprises at least one leading edge cooling channel. The turbine blade further comprises a structure defining with the outer wall a trailing edge cooling circuit adjacent to the trailing edge and extending in a radial direction from the root toward the tip and a structure defining with the outer wall a mid-section cooling circuit located between the leading edge cooling circuit and the trailing edge cooling circuit and defining a forward flow serpentine cooling circuit. The forward flow serpentine cooling circuit comprises a first channel, an intermediate channel, and a final channel, with the mid-section cooling circuit extending in a radial direction from the root toward the tip. The outer wall of the turbine blade further defines an axial tip cooling circuit adjacent to the tip and extending generally continuously in a chordal direction, with the chordal direction extending from the leading edge to the trailing edge. The leading edge, mid-section, and trailing edge cooling circuits each receive a cooling airflow from a cooling air supply at the root. A radially outer portion of each of the leading edge and mid-section cooling circuits further comprise at least one outlet in fluid communication with the axial tip cooling circuit such that substantially all of a leading edge cooling airflow exiting the leading edge cooling circuit and substantially all of a mid-section cooling airflow exiting the mid-section cooling circuit is directed to the axial tip cooling circuit.

In accordance with some aspects, the leading edge and mid-section cooling circuits are coupled to a forward end of the axial tip cooling circuit such that the leading edge cooling airflow exiting the leading edge cooling circuit and the mid-section cooling airflow exiting the mid-section cooling circuit are substantially parallel in an axial direction within the axial tip cooling circuit for at least a portion of a chordal length of the axial tip cooling circuit. In accordance with other aspects, at least one of the intermediate and the final channel of the forward flow serpentine cooling circuit is in fluid communication with the axial tip cooling circuit. In accordance with another aspect of the invention, the structure defining the leading edge cooling circuit comprises first and second walls defining with the outer wall a main leading edge cooling channel and an impingement channel, with the second wall comprising a plurality of radially spaced apart impingement cooling holes such that the leading edge cooling channel and the impingement channel are in fluid communication. In accordance with further aspects of the invention, the tip comprises a plurality of tip cooling holes and the outer wall further comprises a squealer tip rail extending radially outward from the tip, with the squealer tip rail defining a plurality of squealer tip holes.

In accordance with another aspect of the invention, the present disclosure provides a turbine blade comprising an outer wall defining a leading edge, a trailing edge, a pressure side wall, a suction side wall, a radially outer end comprising a tip, and a radially inner end coupled to a root, in which the leading edge has no film cooling holes extending therethrough. The outer wall of the turbine blade defines an axial tip cooling circuit adjacent to the tip and extending continuously in a chordal direction, with the chordal direction extending from the leading edge to the trailing edge. The turbine blade further comprises a structure defining with the outer wall a leading edge cooling circuit for supplying a leading edge cooling airflow, with the leading edge cooling circuit being adjacent to the leading edge and extending in a radial direction from the root toward the tip. The leading edge cooling circuit further comprises a first outlet in fluid communication with the axial tip cooling circuit such that substantially all of a leading edge cooling airflow exiting the leading edge cooling circuit is directed to the axial tip cooling circuit. The turbine blade further comprises a structure defining with the outer wall a trailing edge cooling circuit adjacent to the trailing edge and extending in a radial direction from the root toward the tip. The turbine blade further comprises a structure defining with the outer wall a mid-section cooling circuit for supplying a mid-section cooling airflow, with the mid-section cooling circuit being located between the leading edge cooling circuit and the trailing edge cooling circuit. The mid-section cooling circuit comprises a second outlet in fluid communication with the axial tip cooling circuit such that substantially all of a mid-section cooling airflow exiting the mid-section cooling circuit is directed to the axial tip cooling circuit. The turbine further comprises a partition generally adjacent to the mid-section cooling circuit and the leading edge cooling circuit. The partition extends in the chordal direction and is located such that a partition lower surface is substantially transverse to the mid-section cooling airflow exiting the mid-section cooling circuit.

In accordance with some aspects, the partition is located such that the leading edge cooling airflow exiting the leading edge cooling circuit and the mid-section cooling airflow exiting the mid-section cooling circuit are substantially parallel in an axial direction within the axial tip cooling circuit for at least a portion of a chordal length of the axial tip cooling circuit. In accordance with a particular aspect, the leading edge cooling airflow and the mid-section cooling airflow are substantially parallel for about 40% of the chordal length of the axial tip cooling circuit.

In accordance with other aspects, the mid-section cooling circuit further comprises a first channel, an intermediate channel, and a final channel, with the final channel comprising the second outlet in fluid communication with the axial tip cooling circuit. In accordance with a particular aspect, the mid-section cooling circuit further comprises at least one additional outlet in fluid communication with the axial tip cooling circuit.

In accordance with further aspects, the tip comprises a plurality of tip cooling holes and the outer wall further comprises a squealer tip rail extending radially outward from the tip, with the squealer tip rail defining a plurality of squealer tip holes.

In accordance with another aspect of the invention, the present disclosure provides a method for cooling a turbine blade used in a gas turbine engine. The turbine blade comprises an outer wall defining a leading edge, a trailing edge comprising a plurality of trailing edge exit passages, a pressure side wall, a suction side wall, a radially outer end comprising a tip, and a radially inner end coupled to a root, in which the leading edge has no film cooling holes therethrough. In accordance with one aspect, the method comprises the steps of: supplying a cooling airflow to the turbine blade via the root; passing a portion of the cooling airflow through a leading edge cooling circuit to cool the leading edge of the turbine blade;

passing a portion of the cooling airflow through a mid-section cooling circuit between the leading edge and the trailing edge of the turbine blade; passing a portion of the cooling airflow through a trailing edge cooling circuit to cool the trailing edge and to exit the turbine blade through the plurality of trailing edge exit passages in the outer wall; directing substantially all of a leading edge cooling airflow exiting the leading edge cooling circuit and substantially all of a mid-section cooling airflow exiting the mid-section cooling circuit to an axial tip cooling circuit to generate an axial tip cooling airflow; and passing the axial tip cooling airflow axially within the axial tip cooling circuit in the chordal direction to provide cooling to the tip. The axial tip cooling circuit is adjacent to the tip and extends continuously in a chordal direction, in which the chordal direction extends from the leading edge to the trailing edge.

In accordance with some aspects of the method, the turbine blade further comprises a partition generally adjacent to the mid-section cooling circuit and the leading edge cooling circuit. The partition extends in the chordal direction and is located such that a partition lower surface is substantially transverse to the mid-section cooling airflow exiting the mid-section cooling circuit. In a particular aspect, the method further comprises directing the leading edge cooling airflow and the mid-section cooling airflow within the axial tip cooling circuit such that the leading edge cooling airflow and the mid-section cooling airflow are substantially parallel in an axial direction within the axial tip cooling circuit for at least a portion of a chordal length of the axial tip cooling circuit.

In accordance with other aspects of the method, the leading edge cooling circuit further comprises a wall defining a main leading edge cooling channel and an impingement channel. The wall comprises a plurality of radially spaced apart impingement cooling holes such that the leading edge cooling channel and the impingement channel are in fluid communication. In a particular aspect, the step of passing a portion of the cooling airflow through a leading edge cooling circuit further comprises flowing a portion of the cooling airflow through the plurality of radially spaced apart impingement cooling holes to effect impingement cooling of the leading edge.

In accordance with further aspects of the method, the tip comprises a plurality of tip cooling holes and the outer wall further comprises a squealer tip rail extending radially outward from the tip, with the squealer tip rail defining a plurality of squealer tip holes. In a particular aspect, the method further comprises flowing a portion of the axial tip cooling airflow through the plurality of tip cooling holes and squealer tip holes to effect convective cooling of the tip and the squealer tip rail.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a perspective view of a turbine blade illustrating aspects of the invention;

FIG. 2 is a cross-sectional view taken along view line 2-2 of the turbine blade of FIG. 1;

FIG. 3 is a cross-sectional view taken along a chordal center view line 3-3 of the turbine blade of FIG. 2; and

FIG. 4 is an enlarged view of the radially outer blade tip of FIG. 3.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

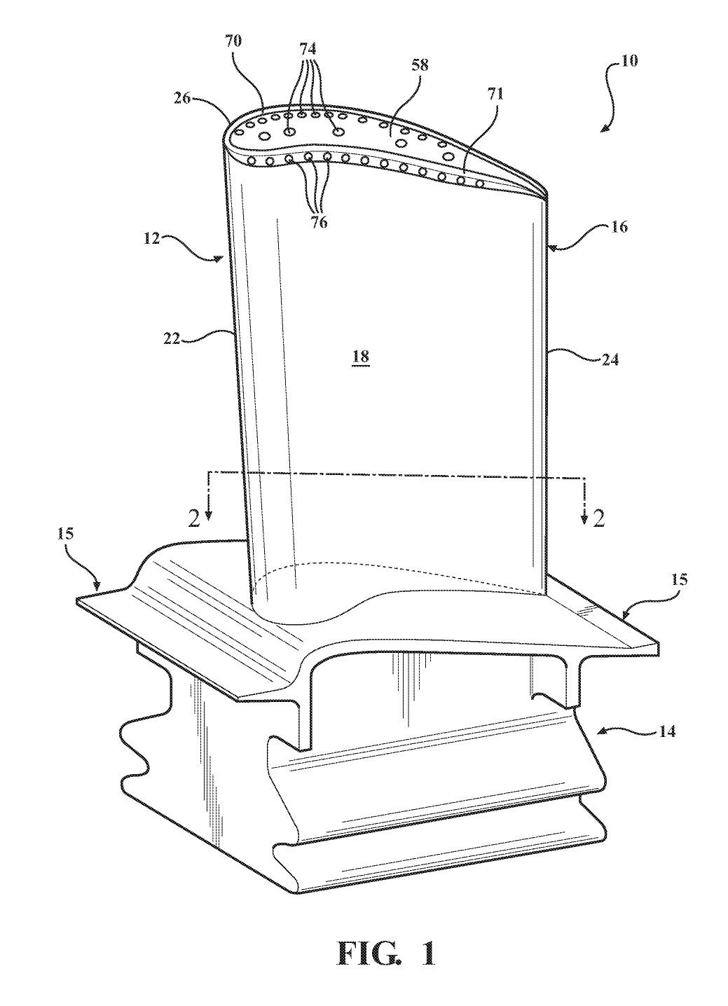

Referring to FIG. 1, in accordance with an aspect of the invention, an airfoil assembly 10 is illustrated. The airfoil assembly 10 may be a blade assembly comprising an airfoil, i.e., a rotatable turbine blade 12, although it is understood that the cooling concepts disclosed herein could be used in combination with a stationary vane. The airfoil assembly 10 is for use in a gas turbine engine. As will be apparent to those skilled in the art, the gas turbine engine includes a compressor section, a combustor section, and a turbine section (not shown). The compressor section includes a compressor that compresses ambient air, at least a portion of which is conveyed to the combustor section. The combustor section includes one or more combustors that mix the compressed air from the compressor section with a fuel and ignite the mixture creating combustion products defining a high temperature working gas. The high temperature working gas travels to the turbine section where the working gas passes through one or more turbine stages, each turbine stage comprising a row of stationary vanes and a row of rotating blades, such as turbine blade 12.

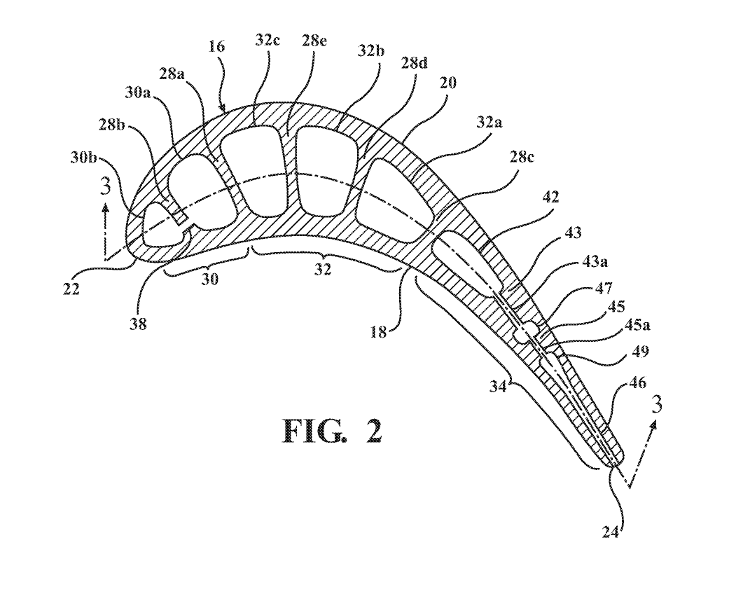

As shown in FIGS. 1 and 2, the turbine blade 12 comprises a root 14 that is coupled to a turbine rotor (not shown) and a platform assembly 15 affixed to the root 14. The blade 12 is affixed to and extends radially outwardly from the platform assembly 15. The blade 12 has an outer wall 16 defining a generally concave pressure side wall 18, a generally convex suction side wall 20, a leading edge 22, and a trailing edge 24. The leading edge 22 is spaced in a chordal direction (represented by line 3-3 in FIG. 2) from the trailing edge 24. The pressure and suction side walls 18, 20 extend radially outwardly in a spanwise or radial direction R_{D} from the platform assembly 15 to a radially outer blade tip 26 and extend in a chordal direction between the leading and trailing edges 22, 24.

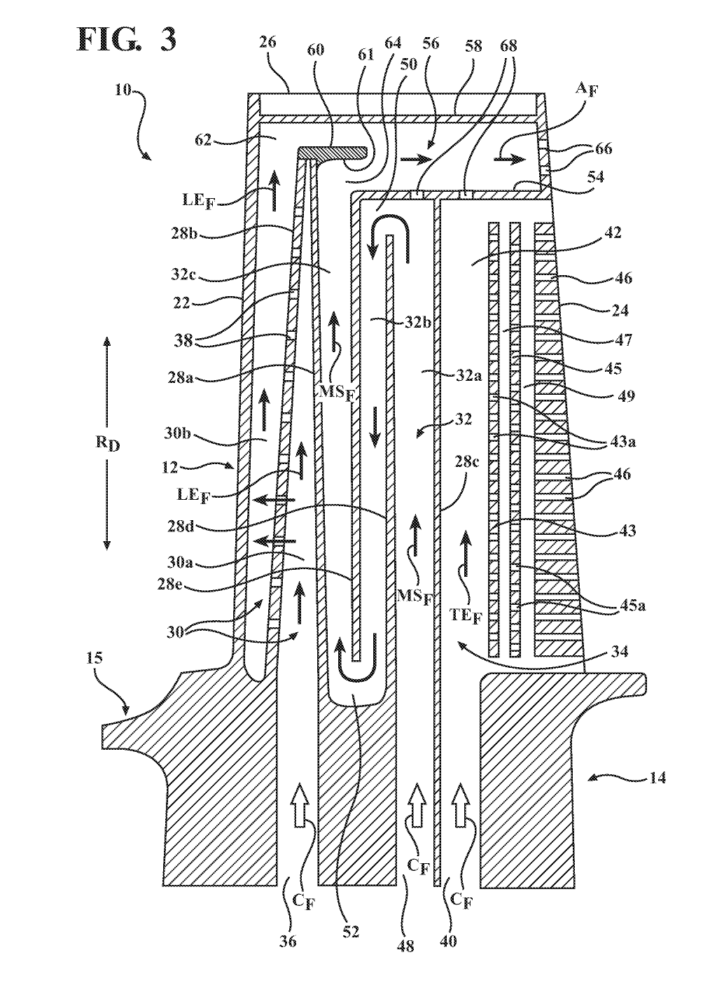

With reference to FIGS. 2 and 3, the outer wall 16 defines a cavity within the blade 12, and a plurality of spanning structures 28 define with the outer wall 16 a plurality of cooling circuits extending radially from the platform assembly 15 to the radially outer blade tip 26 and extending chordally between the leading and trailing edges 22, 24. In particular, the cooling circuits comprise a leading edge cooling circuit 30, a mid-section cooling circuit 32, a trailing edge cooling circuit 34, and an axial tip cooling circuit 56.

The leading edge cooling circuit 30 extends adjacent to the leading edge 22 and is defined in part by the outer wall 16 and a first spanning structure 28a comprising a first wall, substantially solid in the illustrated embodiment, and is located between the pressure and suction side walls 18, 20 and between the leading edge 22 and the first spanning structure 28a. The leading edge cooling circuit 30 extends radially from the platform assembly 15 to the axial tip cooling circuit 56. The leading edge cooling circuit 30 comprises a main leading edge cooling channel 30a defined between the first spanning structure 28a and a second spanning structure 28b comprising a second wall and an impingement channel 30b located upstream of the main leading edge cooling channel 30a and defined between a portion of the outer wall 16 comprising the leading edge 22 and the second spanning structure 28b. The second wall defining the second spanning structure 28b includes a plurality of radially spaced apart impingement holes 38 that allow fluid communication between the main leading edge cooling channel 30a and the impingement channel 30b.

The main leading edge cooling channel 30a is in communication with and receives a cooling airflow C_{F} from a leading edge platform passage 36, which extends through the root 14 and the platform assembly 15. The cooling airflow C_{F} may be provided as cooling air bled from a compressor of the engine and channeled to the rotor disk in a conventional manner. The cooling airflow C_{F} enters the main leading edge cooling channel 30a and flows into the impingement holes 38 to provide impingement cooling to an inner surface of the leading edge 22. As shown in FIG. 3, the second spanning structure 28b may be slightly inclined in an upstream direction such that the first and second spanning structures 28a, 28b meet at a radially outer end of the leading edge cooling circuit 30, thereby forcing all of the cooling airflow C_{F} to enter the impingement channel 30b. As explained in more detail below, the portion of the outer wall 16 defining the leading edge cooling circuit 30 is continuous and does not contain the film cooling holes typically used to provide film cooling to the leading edge 22 of the blade 12 (see FIG. 1).

Continuing to refer to FIGS. 2 and 3, the trailing edge cooling circuit 34 extends adjacent to the trailing edge 24 and is defined in part by the outer wall 16 and a third spanning structure 28c comprising a third wall and is located between the pressure and suction side walls 18, 20 and between the trailing edge 24 and the third spanning structure 28c. The trailing edge cooling circuit 34 extends radially between the platform assembly 15 and a cavity floor 54 that extends between the pressure and suction side walls 18, 20. As shown in FIG. 3, the trailing edge cooling circuit 34 comprises a main trailing edge cooling channel 42. The trailing edge cooling circuit 34 is further defined by first and second ribs 43 and 45, each including respective impingement or metering holes 43a and 45a, and, in part, by the cavity floor 54. Located between the ribs 43 and 45 are first and second trailing edge impingement cavities 47 and 49, which communicate with the main cooling channel 42 and the impingement holes 43a and 45a. Trailing edge discharge slots 46 are located in a portion of the outer wall 16 defining the trailing edge 24. The first and second ribs 43 and 45 and their corresponding impingement holes 43a and 45a provide impingement cooling in the trailing edge cooling circuit 34. The main trailing edge cooling channel 42 is in communication with and receives a cooling airflow C_{F} from a trailing edge platform passage 40 extending through the root 14 and the platform assembly 15. The cooling airflow C_{F} passing through the second trailing edge impingement cavity 49 is discharged through the plurality of trailing edge discharge slots 46 to provide film cooling to the trailing edge 24.

The mid-section cooling circuit 32 is defined by the outer wall 16, the first and third spanning structures 28a, 28c and fourth and fifth spanning structures 28d and 28e comprising fourth and fifth walls and is located between the pressure and suction side walls 18, 20 and the first and third spanning structures 28a, 28c. The mid-section cooling circuit 32 extends radially between the platform assembly 15 and the axial tip cooling circuit 56 and is defined in part by the cavity floor 54. The mid-section cooling circuit 32 is a forward flow serpentine cooling circuit comprising a first channel 32a, an intermediate channel 32b, and a final channel 32c. The first channel 32a, which is defined between the third spanning structure 28c and the fourth spanning structure 28d, is in communication with and receives a cooling airflow C_{F} from a mid-section platform passage 48 extending through the root 14 and the platform assembly 15. The first channel 32a is connected at a radially outer end to the intermediate channel 32b by an outer axial passage 50. The intermediate channel 32b is defined between the fourth spanning structure 28d and the fifth spanning structure 28e and is connected at a radially inner end to the final channel 32c by an inner axial passage 52. The final channel 32c is defined between the fifth spanning structure 28e and the first spanning structure 28a.

The axial tip cooling circuit 56 is defined by the outer wall 16 between the pressure and suction side walls 18, 20 and extends continuously from the leading edge 22 to the trailing edge 24. The axial tip cooling circuit 56 is defined at a radially outer end by the tip cap 58 and at a radially inner end by the leading edge cooling circuit 30, the mid-section cooling circuit 32, and the cavity floor 54. The radially outer end of the impingement channel 30b comprises a leading edge outlet 62 that is in communication with a forward end of the axial tip cooling circuit 56. The radially outer ends of the first and intermediate channels 32a, 32b of the mid-section cooling circuit 32 are defined by the cavity floor 54, and a radially outer end of the final channel 32c comprises a mid-section outlet 64 that is in communication with a forward end of the axial tip cooling circuit 56. The mid-section outlet 64 is located downstream relative to the leading edge outlet 62.

As shown in FIG. 3, cooling airflow C_{F} enters the leading edge, mid-section, and trailing edge platform passages 36, 48, 40 and flows into the leading edge, mid-section, and trailing edge cooling circuits, 30, 32, 34, respectively. A trailing edge cooling airflow TE_{F} enters the main trailing edge cooling channel 42 and flows into the first and second trailing edge impingement cavities 47 and 49 via the impingement holes 43a and 45a and openings above and below the ribs 43 and 45 before being discharged through the trailing edge discharge slots 46 to provide cooling to the trailing edge 24. A leading edge cooling airflow LE_{F} enters the main leading edge cooling channel 30a and flows through the impingement holes 38 into the impingement channel 30b. Substantially all of the leading edge cooling airflow LE_{F} then enters the axial tip cooling circuit 56 via the leading edge outlet 62. A mid-section cooling airflow MS_{F} enters the first channel 32a and flows through the outer axial passage 50 into the intermediate channel 32b. Substantially all of the mid-section cooling airflow MS_{F} then flows into the final channel 32c via the inner axial passage 52 before entering the axial tip cooling circuit 56 through the mid-section outlet 64. The leading edge cooling airflow LE_{F} exiting the impingement channel 30b and the mid-section cooling airflow MS_{F} exiting the final channel 32c of the mid-section cooling circuit 32 combine in the axial tip cooling circuit 56 to form an axial tip cooling airflow A_{F}. The axial tip cooling airflow A_{F} flows in a chordal direction from the leading edge 22 to the trailing edge 24 where it is discharged from the blade 12 via axial tip discharge slots 66.

As illustrated in FIG. 3, the cavity floor 54 may further comprise one or more apertures 68 that connect the mid-section and/or the trailing edge cooling circuits 32, 34 to the axial tip cooling circuit 56. For example, as shown, the portion of the cavity floor 54 near the radially outer end of the first channel 32a of the mid-section cooling circuit 32 comprises an aperture 68 that connects the first channel 32a with the axial tip cooling circuit 56. In addition, the portion of the cavity floor 54 near the radially outer end of the main trailing edge cooling channel 42 comprises an aperture 68 that connects the main trailing edge cooling channel 42 to the axial tip cooling circuit 56.

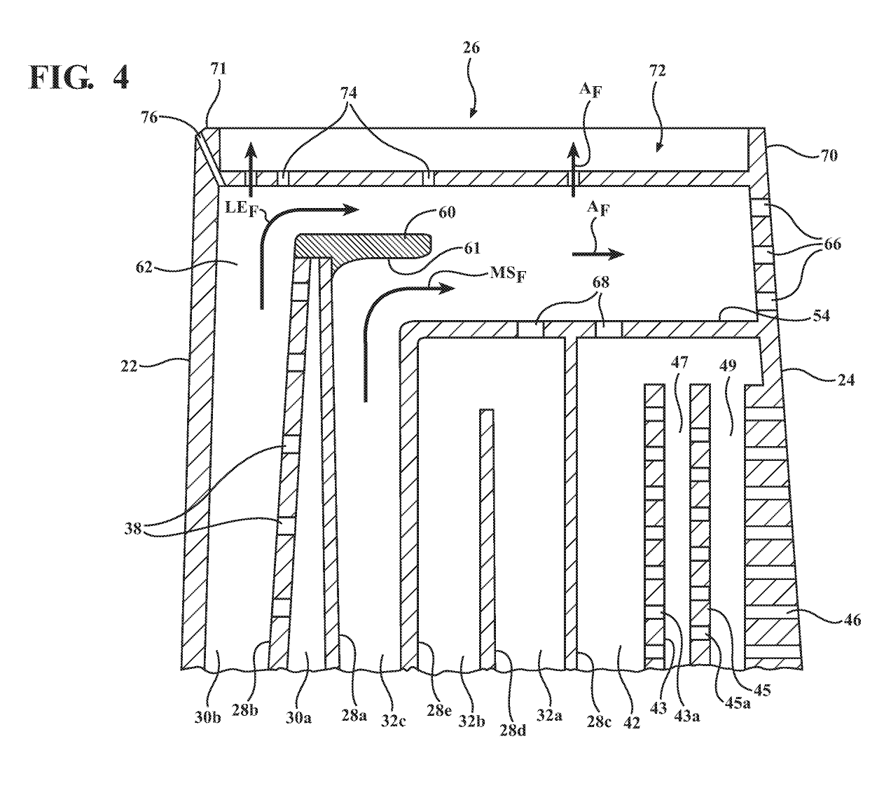

Referring now to FIGS. 1 and 4, the radially outer blade tip 26 of the turbine blade 12 may further comprise a squealer tip rail 70 extending radially outwardly from the tip cap 58 and extending substantially completely around a perimeter of the turbine blade 12 to define an outer squealer tip cavity 72. A plurality of tip cooling holes 74 extending through the tip cap 58 from the axial tip cooling circuit 56 into the squealer tip cavity 72 may be provided. A portion of the axial tip cooling airflow A_{F} may flow through the tip cooling holes 74 to deliver additional convective cooling to the tip cap 58 and the squealer tip rail 70. The squealer tip rail 70 may comprise a plurality of squealer tip holes 76 extending from the axial tip cooling circuit 56 through the squealer tip rail 70. The squealer tip holes 76 may extend through portions of the squealer tip rail 70 adjacent to the leading edge 22 and/or the pressure side wall 18 in the illustrated embodiment. A portion of the axial tip cooling airflow A_{F} may flow through the squealer tip holes 76 to provide cooling to the squealer tip rail 70 and/or the pressure side wall 18. In some aspects of the invention, portions of the squealer tip rail 70 containing the squealer tip holes 76 may optionally comprise a chamfered surface 71 positioned at an acute angle relative to an outer surface of the squealer tip rail 70 as shown in FIGS. 1 and 4.

In the embodiment shown in FIG. 3 and as illustrated in more detail in FIG. 4, the mid-section outlet 64 may be further defined by a partition 60 located generally adjacent to the leading edge and mid-section cooling circuits 30, 32 and extending in a chordal direction within the axial tip cooling circuit 56. The partition 60 may, for example, be coupled to and/or comprise an extension of the first and second spanning structures 28a, 28b. The partition 60 is spaced radially outward with respect to the cavity floor 54 and radially inward with respect to the tip cap 58. The partition 60 extends in a chordal direction such that a partition lower surface 61 is substantially perpendicular or transverse to the mid-section cooling airflow MS_{F} exiting the final channel 32c of the mid-section cooling circuit 32.

The partition 60 prevents flow blockage due to interaction between the leading edge cooling airflow LE_{F} and the warmer mid-section cooling airflow MS_{F}. The partition 60 is located downstream with respect to the leading edge outlet 62 such that the leading edge cooling airflow LE_{F} flows over the partition 60. With the tip cap 58, the partition 60 directs the leading edge cooling airflow LE_{F} in an axial direction through the axial tip cooling circuit 56 toward the trailing edge 24. The partition 60 is located upstream with respect to the mid-section outlet 64. The mid-section cooling airflow MS_{F} is redirected by the partition lower surface 61 in an axial direction through the axial tip cooling circuit 56 toward the trailing edge 24. The leading edge cooling airflow LE_{F} and the mid-section cooling airflow MS_{F} flow substantially in parallel through at least a portion of the axial tip cooling circuit 56 from the leading edge 22 to the trailing edge 24 to form the axial tip cooling airflow A_{F}, which provides additional cooling to the radially outer blade tip 26 and the squealer tip rail 70. In some aspects of the invention, the partition 60 may extend the separate, axial airflow of the leading edge cooling airflow LE_{F} by up to 40% of the chordal length of the axial tip cooling circuit 56. It is contemplated that the partition 60 may have a length from about 15% to about 25% of the chordal length of the axial tip cooling circuit 56.

Unlike many conventional turbine blades, a turbine blade according to the present invention does not include film cooling holes in a showerhead arrangement on the leading edge or along the body of the turbine blade (see FIG. 1). Deposits can cause these film cooling holes to become clogged during operation, particularly in turbine engines burning a heavy oil such as crude oil. Lack of sufficient cooling can cause severe damage to the blades, including leading edge and tip burnout. Turbine blades with enhanced internal cooling as disclosed herein make more efficient use of the available cooling airflow with little or no film cooling.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A turbine blade comprising:
an outer wall defining a leading edge, a trailing edge, a pressure side wall, a suction side wall, a radially outer end comprising a tip, and a radially inner end coupled to a root, wherein the leading edge has no film cooling holes extending therethrough;
a structure defining with the outer wall a leading edge cooling circuit adjacent to the leading edge and extending in a radial direction from the root toward the tip, the leading edge cooling circuit comprising at least one leading edge cooling channel;
a structure defining with the outer wall a trailing edge cooling circuit adjacent to the trailing edge and extending in a radial direction from the root toward the tip;
a structure defining with the outer wall a mid-section cooling circuit located between the leading edge cooling circuit and the trailing edge cooling circuit and defining a forward flow serpentine cooling circuit comprising a first channel, an intermediate channel, and a final channel, the mid-section cooling circuit extending in a radial direction from the root toward the tip; and
the outer wall further defining an axial tip cooling circuit adjacent to the tip and extending generally continuously in a chordal direction, wherein the chordal direction extends from the leading edge to the trailing edge,
wherein the leading edge cooling circuit, the mid-section cooling circuit, and the trailing edge cooling circuit each receive a cooling airflow from a cooling air supply at the root and wherein a radially outer portion of each of the leading edge cooling circuit and the mid-section cooling circuit further comprises at least one outlet in fluid communication with the axial tip cooling circuit such that substantially all of a leading edge cooling airflow exiting the leading edge cooling circuit and substantially all of a mid-section cooling airflow exiting the mid-section cooling circuit is directed to the axial tip cooling circuit.

2. The turbine blade of claim 1, wherein the leading edge cooling circuit and the mid-section cooling circuit are coupled to a forward end of the axial tip cooling circuit such that the leading edge cooling airflow exiting the leading edge cooling circuit and the mid-section cooling airflow exiting the mid-section cooling circuit are substantially parallel in an axial direction within the axial tip cooling circuit for at least a portion of a chordal length of the axial tip cooling circuit.

3. The turbine blade of claim 1, wherein at least one of the intermediate channel and the final channel of the forward flow serpentine cooling circuit is in fluid communication with the axial tip cooling circuit.

4. The turbine blade of claim 1, wherein the structure defining the leading edge cooling circuit comprises first and second walls defining with the outer wall a main leading edge cooling channel and an impingement channel, the second wall comprising a plurality of radially spaced apart impingement cooling holes such that the leading edge cooling channel and the impingement channel are in fluid communication.

5. The turbine blade of claim 1, wherein the tip comprises a plurality of tip cooling holes, and wherein the outer wall further comprises a squealer tip rail extending radially outward from the tip, the squealer tip rail defining a plurality of squealer tip holes.

6. A turbine blade comprising:
an outer wall defining a leading edge, a trailing edge, a pressure side wall, a suction side wall, a radially outer end comprising a tip, and a radially inner end coupled to a root, wherein the leading edge has no film cooling holes extending therethrough;
the outer wall defining an axial tip cooling circuit adjacent to the tip and extending continuously in a chordal direction, wherein the chordal direction extends from the leading edge to the trailing edge;
a structure defining with the outer wall a leading edge cooling circuit for supplying a leading edge cooling airflow, the leading edge cooling circuit being adjacent to the leading edge and extending in a radial direction from the root toward the tip, wherein the leading edge cooling circuit further comprises a first outlet in fluid communication with the axial tip cooling circuit such that substantially all of a leading edge cooling airflow exiting the leading edge cooling circuit is directed to the axial tip cooling circuit;
a structure defining with the outer wall a trailing edge cooling circuit adjacent to the trailing edge and extending in a radial direction from the root toward the tip;
a structure defining with the outer wall a mid-section cooling circuit for supplying a mid-section cooling airflow, the mid-section cooling circuit being located between the leading edge cooling circuit and the trailing edge cooling circuit, wherein the mid-section cooling circuit comprises a second outlet in fluid communication with the axial tip cooling circuit such that substantially all of a mid-section cooling airflow exiting the mid-section cooling circuit is directed to the axial tip cooling circuit; and
a partition generally adjacent to the mid-section cooling circuit and the leading edge cooling circuit, the partition extending in the chordal direction, wherein the partition is located such that a partition lower surface is substantially transverse to the mid-section cooling airflow exiting the mid-section cooling circuit.

7. The turbine blade of claim 6, wherein the partition is located such that the leading edge cooling airflow exiting the leading edge cooling circuit and the mid-section cooling airflow exiting the mid-section cooling circuit are substantially parallel in an axial direction within the axial tip cooling circuit for at least a portion of a chordal length of the axial tip cooling circuit.

8. The turbine blade of claim 7, wherein the leading edge cooling airflow and the mid-section cooling airflow are substantially parallel for about 40% of the chordal length of the axial tip cooling circuit.

9. The turbine blade of claim 6, wherein the mid-section cooling circuit further comprises a first channel, an intermediate channel, and a final channel, the final channel comprising the second outlet in fluid communication with the axial tip cooling circuit.

10. The turbine blade of claim 9, wherein the mid-section cooling circuit further comprises at least one additional outlet in fluid communication with the axial tip cooling circuit.

11. The turbine blade of claim 6, wherein the tip comprises a plurality of tip cooling holes, and wherein the outer wall further comprises a squealer tip rail extending radially outward from the tip, the squealer tip rail defining a plurality of squealer tip holes.

12. A method for cooling a turbine blade used in a gas turbine engine, the turbine blade comprising an outer wall defining a leading edge, a trailing edge comprising a plurality of trailing edge exit passages, a pressure side wall, a suction side wall, a radially outer end comprising a tip, and a radially inner end coupled to a root, wherein the leading edge has no film cooling holes therethrough, the method comprising the steps of:
supplying a cooling airflow to the turbine blade via the root;
passing a portion of the cooling airflow through a leading edge cooling circuit to cool the leading edge of the turbine blade;
passing a portion of the cooling airflow through a mid-section cooling circuit between the leading edge and the trailing edge of the turbine blade;
passing a portion of the cooling airflow through a trailing edge cooling circuit to cool the trailing edge and to exit the turbine blade through the plurality of trailing edge exit passages in the outer wall;
directing substantially all of a leading edge cooling airflow exiting the leading edge cooling circuit and substantially all of a mid-section cooling airflow exiting the mid-section cooling circuit to an axial tip cooling circuit to generate an axial tip cooling airflow, wherein the axial tip cooling circuit is adjacent to the tip and extends continuously in a chordal direction, the chordal direction extending from the leading edge to the trailing edge; and
passing the axial tip cooling airflow axially within the axial tip cooling circuit in the chordal direction to provide cooling to the tip.

13. The method of claim 12, wherein the turbine blade further comprises a partition generally adjacent to the mid-section cooling circuit and the leading edge cooling circuit, the partition extending in the chordal direction, wherein the partition is located such that a partition lower surface is substantially transverse to the mid-section cooling airflow exiting the mid-section cooling circuit.

14. The method of claim 13, further comprising directing the leading edge cooling airflow and the mid-section cooling airflow within the axial tip cooling circuit such that the leading edge cooling airflow and the mid-section cooling airflow are substantially parallel in an axial direction within the axial tip cooling circuit for at least a portion of a chordal length of the axial tip cooling circuit.

15. The method of claim 12, wherein the leading edge cooling circuit further comprises a wall defining a main leading edge cooling channel and an impingement channel, the wall comprising a plurality of radially spaced apart impingement cooling holes such that the leading edge cooling channel and the impingement channel are in fluid communication.

16. The method of claim 15, wherein the step of passing a portion of the cooling airflow through a leading edge cooling circuit further comprises flowing a portion of the cooling airflow through the plurality of radially spaced apart impingement cooling holes to effect impingement cooling of the leading edge.

17. The method of claim 12, wherein the tip comprises a plurality of tip cooling holes, and wherein the outer wall further comprises a squealer tip rail extending radially outward from the tip, the squealer tip rail defining a plurality of squealer tip holes.

18. The method of claim 17, further comprising flowing a portion of the axial tip cooling airflow through the plurality of tip cooling holes and squealer tip holes to effect convective cooling of the tip and the squealer tip rail.
